(19) United States
(12) Patent Application Publication
(10) Pub. No.: US 2024/0054479 A1
(43) Pub. Date: Feb. 15, 2024

(54) SYSTEMS AND METHODS FOR OPEN, SECURE, ENCRYPTED CURRENCY EXCHANGE AND SMART CONTRACT TRANSACTIONS

(71) Applicant: Wyre, Inc., San Francisco, CA (US)

(72) Inventors: Craig Lou, Plymouth, MI (US); Samuel Schlachter, Washington Crossing, PA (US); Salim Hamza, Mandeville (CA)

(21) Appl. No.: 17/884,439

(22) Filed: Aug. 9, 2022

(51) Int. Cl. G06Q 20/36; G06Q 20/38

(52) U.S. Cl. CPC G06Q 20/367; G06Q 20/3825; G06Q 20/389

(57) ABSTRACT

Techniques for open, secure, encrypted currency exchange and smart contract transactions include executing a script for receiving input indicating an item for purchase, or other transaction. The script can be used to determine a price of the item, and a transaction fee responsive to the price and the input indicating the item. The script can determine the transaction fee in a first currency, for example a fiat currency. A first wallet can be configured to receive payment in the fiat currency; e.g., where the payment is equal to or greater than a sum of the price and the transaction fee. The script can also identify one or more digital assets to be provided from a second wallet, responsive to receiving the payment, and to identify the item to be purchased to one or more smart contracts that are executable to purchase the item.

### BACKGROUND

Digital assets, such as cryptocurrencies, have garnered international attention in recent years. Transactions using cryptocurrencies are verified and records of those transactions are maintained by a decentralized system rather than by traditional financial institutions such as banks and credit card processing agencies. Transactions associated with a unit of cryptocurrency or other digital assets are often stored in a decentralized ledger. The ledger may be implemented in a blockchain, which stores information of each transaction in a separate “block.” Each block points to the previous block, forming a “chain” that provides a chronological record of transactions.

These immutable ledgers and decentralized systems associated with digital assets are two features that have contributed to growing interest in cryptocurrencies and other digital assets. However, digital assets and associated services are still in nascent form. This makes it difficult for established companies, such as online retailers and physical establishments, to adopt the use of digital assets. Accordingly, tools and techniques for making cryptocurrencies and digital assets easier to integrate into existing business models are desired.

### SUMMARY

Techniques for open, secure, encrypted currency exchange and smart contract transactions are described. Applications include a script configured for receiving input indicating an item for purchase or other transaction, determining a price of the item, and determining a transaction fee responsive to the price and the input. The script can also determine the price of the item and transaction fee in a first currency, for example a fiat currency. A first wallet can be configured to receive payment in the first (fiat) currency; e.g., where the payment is equal to or greater than a sum of the price and the transaction fee. The script can also identify a digital asset to be provided from a second wallet, responsive to receiving the payment, and then identify the item to a smart contract, where smart contract is executable to purchase the item.

### BRIEF DESCRIPTION OF THE DRAWINGS

FIG. 1A is a schematic view of a vending machine system illustrating a purchase transaction executable by the exchange of fiat currency.

FIG. 1B is a schematic view of a smart ramp transaction system illustrating a smart ramp purchase executable by the exchange of fiat currency for an NFT in accordance with an example of the present disclosure.

FIG. 2 is a block diagram of a decentralized swap protocol system in accordance with an example of the present disclosure.

FIG. 3 is a block diagram of a system for purchasing a basket of NFT or other digital tokens via a decentralized swap protocol in accordance with an example of the present disclosure.

FIG. 4 is a flow chart illustrating the execution flow of a smart ramp in accordance with an example of the present disclosure.

FIG. 5 illustrates the flow of assets implemented by the smart ramp according to an example of the present disclosure.

FIG. 6 is a schematic illustration of a computing device arranged in accordance with examples of the present disclosure.

### DETAILED DESCRIPTION

Certain details are set forth below to provide a sufficient understanding of examples of the disclosure. However, it will be clear to one having skill in the art that examples of the disclosure may be practiced without these particular details. Moreover, the particular examples of the present disclosure described herein should not be construed to limit the scope of the disclosure to these particular examples. In other instances, well-known modules, circuits, network components, and software operations have not been shown in detail in order to avoid unnecessarily obscuring the disclosure. Additionally, terms such as “couples” and “coupled” mean that two components may be directly or indirectly electrically coupled or in electronic communication with one another whether via wired or wireless connections. Indirectly coupled may imply that two components are coupled through one or more intermediate components.

Currently, if a customer wants to buy an item (physical or digital) offered for sale in exchange for a digital asset (e.g., a cryptocurrency) by a business, the customer must first set up a “wallet” to send and receive cryptocurrency and other digital assets such as non-fungible tokens (NFT). A wallet is a software tool that allows the customer to interact with blockchain networks. The wallet has an address and is associated with one or more keys. Some of the keys are public, which allow digital assets to be delivered to the customer, somewhat similar to bank routing and account numbers. Some of the keys are private, which are used for signatures and transactions, somewhat analogous to a pin number or password for a bank account. Typically, a wallet has two keys, one private and one public. The public key may be derived from the private key and the wallet address is derived from the public key. The wallet may allow digital assets to be delivered to the wallet owner (e.g., customer).

After the customer has set up a wallet, the customer must go to an onramp to purchase the digital asset. An onramp allows the customer to exchange fiat currency (e.g., U.S. dollars, Euros) for a digital asset, typically a cryptocurrency (e.g., Bitcoin, Ethereum). The onramp only facilitates this initial transaction, and the customer must take further action to purchase the item (assuming the digital asset is not the final item the customer wants). Once the customer has successfully purchased the cryptocurrency, the customer may go to the business (e.g., go to the business's website) and purchase the item in exchange for the cryptocurrency. In some applications, the business may not be a centralized entity as is typical for an ecommerce website. Rather, the business may be a decentralized platform that facilitates transactions between parties.

However, there are many types of cryptocurrencies and digital assets. Even if a customer already has a wallet and owns cryptocurrency, the customer may need to exchange their cryptocurrency for another cryptocurrency or digital asset if the item they want to purchase is only offered in the other cryptocurrency/asset. Further, various cryptocurrencies and digital assets may be associated with different blockchains. For example, different chain types may use different software languages, cryptography algorithms, communication protocols, or combinations thereof. The customer may need multiple wallets that support different blockchain networks for the digital assets they want to use and/or digital assets they want to receive. Further, each transaction incurs a transaction fee, so the customer must ensure that, in addition to the price of the item they want to purchase, they provide sufficient “gas money” to cover the transaction fees.

Distrust of digital assets and/or frustration with navigating the variety of networks may discourage customers from making purchases with digital assets and/or purchasing digital assets. Similar factors may discourage businesses from accepting digital assets in exchange for items or cause businesses to lose sales when items may only be purchased via digital assets such as cryptocurrencies.

According to the techniques disclosed herein, a user or customer may provide inputs to a “smart ramp.” In some examples, the inputs may identify a fiat currency and an item the customer wishes to purchase. In some examples, the inputs may include a digital currency or asset of the customer and an item or digital asset the customer wishes to purchase. The smart ramp may include one or more scripts. In some examples, each script (which may also be referred to as a smart script) is associated with one or multiple transactions. Which script is executed by the smart ramp may be based, at least in part, on the type of currency, the type of digital asset or currency to be used, the item or digital asset to be purchased, transactional characteristics of the associated blockchain network(s), and/or other factors. When executed, the script may cause the execution of multiple transactions to complete the purchase of the item. The item may be physical or another digital asset (e.g., NFT). At least one of the transactions includes exchanging the fiat currency for a digital asset (e.g., a cryptocurrency) that is different from the item. At least some of the multiple transactions may be on-chain transactions.

Unlike existing onramps that only allow a customer to exchange fiat currency for an intermediate digital asset (e.g., a cryptocurrency) that will be exchanged for the item, the smart ramp allows a customer to purchase an item with fiat currency, even if the item is offered in exchange for a digital asset. Similarly, the smart ramp allows a customer to purchase an item with a digital asset or digital currency, even if the item is offered in exchange for a different digital asset. The smart ramp executes intermediate transactions (e.g., calculating exchange rates, calculating transaction fees, purchasing digital assets, purchasing the item in exchange for the digital asset) and delivers the item (or arranges for delivery of the item in the case of physical items) to the customer. The customer does not need to exchange their fiat currency for a digital asset, calculate transaction fees, and exchange the digital asset for the desired item. Depending on the item purchased, the customer may or may not need to set up a wallet. Thus, from the perspective of the customer, a single transaction occurs in fiat currency for the item, similar to existing ecommerce sites (e.g., buying an ebook download from an online bookstore or a shirt from an online clothing store).

By adding smart ramp functionality, a business may accept cryptocurrency or other digital assets as tender, but the complexity typically associated with digital asset transactions may be reduced or eliminated for customers. This may allow more businesses to adopt digital assets without alienating their customer base.

While the examples described herein refer to “customer” and “business” it should be understood that these are provided merely as illustrative examples, and the use of smart ramps is not limited to customer-to-business (C2B) transactions. Smart ramps may also be used in business-to-business transactions (B2B), transactions between private individuals, transactions between different divisions of a business entity, and other applications.

Blockchain networks are made of multiple participants or nodes. Each node may include one or more computing devices. The computing devices each include data processing and storage capabilities. All of the nodes of a blockchain network may include a record of all of the blockchains (which may be referred to simply as chains). A transaction may be initiated in the blockchain network by “broadcasting” the transaction to the blockchain network, which causes the transaction to be received by one or more of the nodes. The broadcast may be provided to the blockchain network by a computing device that may or may not act as a node in the blockchain network. The “broadcast” may include details of the transaction to be executed such as assets involved and nature of the transaction (e.g., transfer, exchange, etc.). When a transaction involving one or more of the chains occurs, the nodes verify and approve the transaction. A new block representing the transaction is added to the one or more chains to provide a record of the transaction. The new block is added to all of the records of the chain at all of the nodes in the blockchain network. Execution of the transaction involving the chains is then complete. In some applications, the computing device that broadcasts the transaction may receive a confirmation from the blockchain network when the execution is complete. In some applications, the computing device may monitor the chain(s) and recognize that execution is complete when a new block(s) representing the transaction are added to the chain(s).

Techniques for verifying, approving, and recording transactions vary based on the transaction and/or protocols of the blockchain network. For example, different inputs for the broadcast may be required for successful execution of the transaction and/or certain transactions may require the addition of multiple blocks to the chain or chains involved in order to record the transaction. Different techniques for sharing verification, approval, and/or recording tasks across the nodes may vary between blockchain networks. Different blockchain networks use different structures for blocks of the chain. Different inputs, outputs, data structures, software language, maximum/minimum sizes, are non-limiting examples of possible differences between blocks of different blockchain networks.

Further, in some blockchain networks, blockchains are not limited to being used as ledgers. Blocks may also include executable code. For example, smart contracts may be included in the blockchain. Smart contracts are contracts that are automatically executed when conditions are met. For example, a smart contract may be used to exchange one cryptocurrency for another when an exchange rate is equal to or above a desired rate. In another example, an owner of a unit of cryptocurrency may gift the unit of cryptocurrency to a friend, but set up a smart contract such that the unit of cryptocurrency is not transferred to the friend until a date determined by the owner (e.g., the friend's birthday).

Smart contracts are contracts expressed as pieces of on-chain code that are designed to automatically execute a set of instructions once certain conditions are met. Vending machines can be used as a real-world analogy of a smart contract. A user can decide what they want, and insert money (e.g., denominated in fiat currency) into the machine (e.g., a smart contact executable via a blockchain network). Once the user clicks on a button or inserts a code for a desired item of the same value (or less), the machine automatically releases the item (e.g., executing the smart contract via the blockchain network, once the required conditions are met).

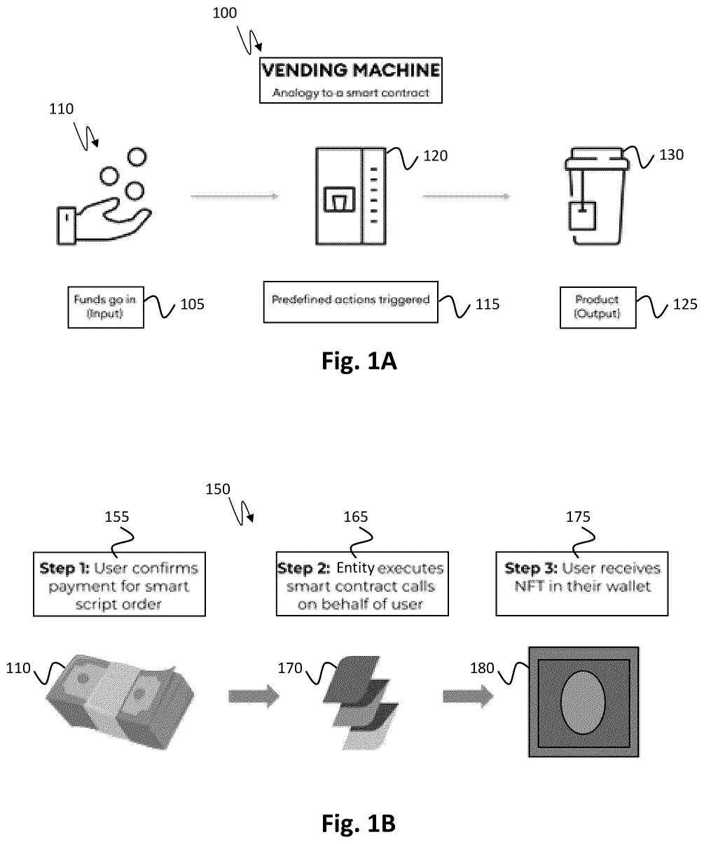

FIG. 1A is a schematic view of a vending machine system 100, illustrating a purchase transaction executable by the exchange of fiat currency. As shown in FIG. 1A, system 100 operates on hard currency 110, for example coins or bills that can be inserted into a mechanical apparatus 120 configured to provide a user product 130, for example a cup of tea or other beverage.

Vending machine system 100 operates analogously to a smart contact, triggered via the transfer of fiat currency 110 at step 105. The input can also be performed via an electronic transfer; e.g., using a card (credit/debit) or fiat-based electronic wallet.

The input of funds (step 105) triggers a number of predefined actions in the apparatus 120 (step 115), for example dispensing a selected beverage into a cup. When complete, the product (130) or other output is presented to the user (step 125).

When a smart contract is included in a block of a chain in a blockchain network, the code of the smart contract is executed by one or more nodes of the blockchain network. Execution of the code may cause the one or more nodes to analyze data provided to the blockchain network to determine whether the required conditions of the smart contract are met. The data may be provided from another computing device or network (e.g., a stock exchange, an inventory management server). The data may be received continuously or periodically. When analysis of the data indicates the conditions of the smart contract have been met, the blockchain network may execute the one or more transactions indicated by the smart contract and the affected chains are updated accordingly.

An Application Programming Interface (API) facilitates communication between two or more software programs. For example, an API may allow an ecommerce site to provide information provided by a customer to a blockchain network via a script in a format the blockchain network can process. Some APIs may function and/or communicate with other software via scripts. Scripts are pieces of code that are typically interpreted at runtime rather than compiled. For example, scripts may be used to provide inputs to the API and outputs from the API may be provided as scripts.

In the smart contract context, a script may include a contract call to a blockchain network or cause a contract call to be made to the blockchain network. The contract call may provide information to a blockchain network indicating that the conditions of one or more smart contracts have been met and should be executed by the blockchain network. In some applications, the contract call may be broadcast like other transactions. A smart script may receive output generated by the blockchain network and provide the output to an API, which may in turn allow the output to be provided to another computing device or network (e.g., an exchange or ecommerce site).

The use of smart contracts provides a number of important advantages, as compared to the traditional fiat-based system 100, but it presents a number of technical challenges as well. For example, smart contracts can facilitate exchanges between and among fiat-based currencies and blockchain-based currencies (crypto-currencies), but requires navigating multiple chains requiring individual users to understand the nuances of each chain and specialized skills required to bridge among the chains. When multiple services (coinbase, bridges, etc.) are involved, multiple transactions must typically occur (e.g., via smart contracts or other blockchain transactions) in order to obtain a certain output. Smart contracts may suffer from time constraints, for example in executions like non-fungible token (NFT) purchases, which can be time sensitive.

Traditionally, executing multiple on-chain transactions can be both time consuming and error-prone. Managing “gas” (the fee or pricing value required to successfully conduct a transaction or execute a contract) can also be an issue, and having enough gas for each transaction adds complexity to the problem. For example, if a user has failed to consider all of the transaction fees, the conditions for execution of a smart contract may fail. Returning to the vending machine analogy of FIG. 1A, running out of gas may be considered akin to the vending machine's electricity being shut off. More generally, these issues may have in some cases contributed to a negative outlook towards digital currency transactions by users, and even by some more traditional financial institutions, resulting in relatively lower approval rates for certain cryptocurrency transaction services. These issues can be addressed with better smart script and smart ramp technologies, as described herein.

A smart ramp (“SmartRamp”) is a collection of one or more scripts. Each script may cause execution of one or more transactions, such as smart contract calls. When executed, the script results in an output. The output can range from NFT exchanges to yield-generating tokens. However, the output need not be limited to digital assets. For example, a smart contract could trigger shipment of a physical item (e.g., book, trading card).

In the example of a user (e.g., customer) wishing to purchase an NFT, the user may invoke a smart script of the smart ramp by completing a transaction, such as a wallet order transaction; e.g. using a credit card or other fiat-based currency source. This will result in execution of a sequence of one or more smart contract calls by the smart ramp, on behalf of the user. Once the calls have been successfully executed, the user will receive the output (e.g., the NFT) in their wallet.

FIG. 1B is a schematic view of a smart ramp transaction system 150, illustrating a smart ramp purchase executable by the exchange of fiat currency for an NFT in accordance with an example of the present disclosure. As shown in FIG. 1B, fiat currency 110 can be input to system 150, for example using a card or electronic wallet-based source, for which the user first confirms payment for a smart script order (step 155). Second, the system 150 executes calls for one or more smart contacts 170, on behalf of the user (step 165). Third, the user receives an NFT 180 in their wallet (step 175). While shown as a linear series, in some examples, the steps may be performed in different orders or combinations that are suitable to facilitate an open, secure, trusted, encrypted currency/NFT exchange via smart contract-based transactions, as described herein. For example, in some applications, a user's confirmation may be omitted (step 155). In another examples, step 165 may be performed, at least in part, in parallel with step 155 and/or step 175. Other changes and combinations are also possible, as understood by a person of skill in digital transaction services, having read the present disclosure as a whole.

In some examples, a smart ramp includes script that may cause a sequence of one or more on-chain transactions to be executed by an exchange service provider or other blockchain network, on behalf of an end user. The transaction payments can be made via an end-user fiat payment method, for example a card or wallet-based fiat currency source. In some examples, the output of the smart ramp transaction can be any token ranging from digital assets like NFTs to DOA (decentralized autonomous organization) governance tokens. However, the output of the smart ramp transaction may include more “traditional” digital assets, such as music files delivered to a user's account (e.g., Amazon Music, iTunes) or ebooks delivered to a user's device (e.g., Kindle, iPad). Further, the output of a smart ramp transaction may be the execution of an order for a physical item (e.g., fulfillment instructions may be provided to a distributor or warehouse).

Smart ramps can be adapted to solve a number of technical problems. Multi-chain smart scripts can be adapted to execute smart scripts on a range of supported smart contract chains. Multi-transaction smart scripts can be adapted to execute any number of transactions. Users thus only have to place a one-step smart script wallet order, in order to obtain the desired output.

Multi-contract smart scripts can be adapted to make calls to one or more smart contracts. The gas fees for each smart script transaction can be aggregated into one network fee by the smart ramp, and the smart ramp may allow the aggregated network fee to be paid in fiat currency or other digital asset (e.g., cryptocurrency). In some cases, the smart ramp may further calculate a fee charged by a card and include the fee in the aggregated network fee. Buying (physical or digital) goods directly with fiat such as direct NFT purchases, can reduce end-user time and expertise requirements, and result in higher end-user approval rates by utilizing the appropriate digital or physical goods merchant category code (MCC).

As described, inputs to the smart ramp may include a fiat currency and an item the user wishes to purchase. While the smart ramp may cause multiple transactions, including smart contracts, to be executed, in some embodiments, the user “sees” only a single transaction—the providing of the fiat currency in exchange for the item. An example of a smart ramp for purchasing an NFT is provided herein. However, the purchase of an NFT is provided solely for illustrative purposes and smart ramps are not limited to the purchase of an NFT.

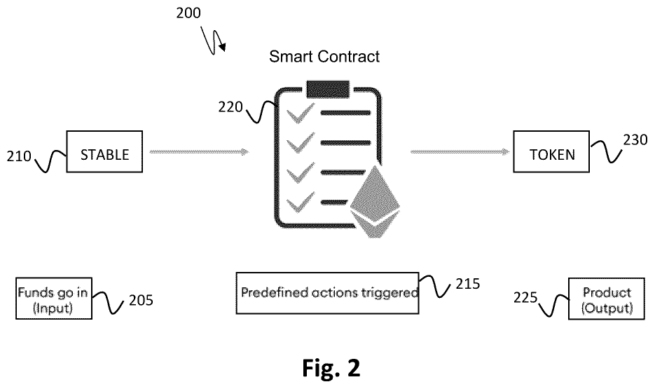

FIG. 2 is a block diagram of a decentralized swap protocol system 200 in accordance with an example of the present disclosure. As shown in FIG. 2, system 200 operates via input of a stable cryptocurrency token 210 (e.g., USDC or other stabilized digital asset, with defined value in a selected fiat currency such as the U.S. dollar). The input token 210 is accepted at step 205, where the funds enter (“go into”) system 200. This triggers one or more calls for execution of one or more smart contracts 220, or other predefined actions (step 215). A digital token 230 is output as the product of the transaction (step 225), for example a “smart” property such as an ERC token or other tokenized digital asset. Depending on application, the token 230 may also be held for investment, traded, and/or used to create and issue additional smart contracts 220.

Swaps are decentralized swap protocols for digital assets such as fungible tokens, for example ERC (Ethereum request for comment) tokens and other mutually interchangeable electronic assets. With smart scripts, users can purchase a basket of such tokens or NFTs via the swap protocol (e.g., Niftyswap protocol), on a suitable blockchain layer network such as Polygon, or another layer-2 network that does not change the underlying (original) blockchain layer. In some examples, the smart script may make the purchase on Ethereum or other blockchain network with a suitable swap protocol. More generally, any suitable decentralized blockchain network platform may be used, or any suitable combination of such platforms, where the smart scripts are adapted accordingly.

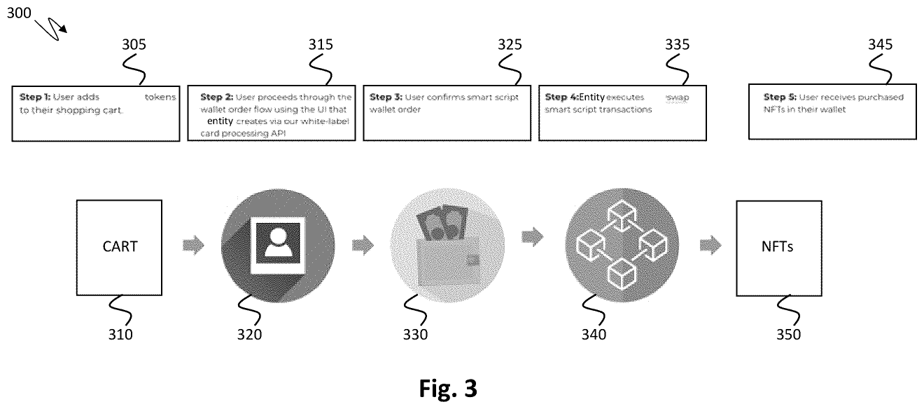

FIG. 3 is a block diagram of a system 300 for purchasing a basket of NFT or other digital tokens via a decentralized swap protocol; e.g., on a suitable level-2 blockchain network, in accordance with an example of the present disclosure. Examples of suitable swap protocols include Niftyswap and Uniswap, but other automated token exchange protocols may also be used, either alone or in combination, depending on application. As shown in FIG. 3, users can add ERC tokens or similar digital assets (step 305) to their shopping cart 310. The user proceeds through an order flow (step 315) for a wallet order 320; e.g. via a user interface (UI) created via a card-processing application programming interface (API), for example a smart scrip API adapted for generating a range of suitable user interfaces.

The user confirms the smart script order 330 at step 325. In response, the transaction provider executes the smart script transactions 340 (step 335). The user then receives the NFTs 350, or other purchased digital asset; e.g., in their designated wallet (step 345).

These steps can be performed in any order or combination. The system 300 can also be adapted for additional swap protocols, including, but not limited to, Uniswap V1, V2, V3 and other decentralized swap protocols for fungible tokens. Automated clearing house (ACH) payments and other bank-to-bank or non-banking financial institution (NBFI) transactions can also be enabled; e.g., using a combination of internal and external smart scripts.

While reference has been made to the user and the smart ramp executing transactions on behalf of the user, in some applications, the user may not directly interact with the smart ramp. Rather, the smart ramp may be invoked on behalf of the user by another entity, such as a business (e.g., store, exchange) selling items the user wishes to purchase. In some examples, the user may make a purchase from the entity via a graphical user interface (GUI) of a site or mobile application associated with the entity. In some examples, the entity's GUI may be built on top of the API of the smart ramp. In some examples, the smart ramp functions may be provided, at least in part, by another entity (e.g., a trusted transaction service provider or “smart entity”). For example, suitable service providers may include, but are not limited to, Wyre, SendWyre, and Wyre Payment services, available from Wyre, Inc. of San Francisco, California.

The user may see a GUI where the user clicks on images the desired items to put the items in a “shopping cart.” When the user is ready, the user “checks out” by entering various information (e.g., credit card information, address). The user may be prompted one or more times to confirm the purchase prior to the purchase being executed. For example, the GUI may request the user confirm the items selected are the items the user wishes to purchase. For example, the GUI may present the user with estimated network fees and/or credit card fee associated with the transaction and prompt the user to confirm the user wishes to continue with the purchase.

The site or application may provide the user's inputs, along with other information related to the transaction via an API call (e.g., to the smart entity or service provider) to initiate the smart ramp. The smart ramp may cause execution of the transactions (e.g., via a smart script), such as smart contracts, on behalf of the user and the entity responsive to the inputs provided from the entity's site or application. When the entity makes a call to the API, the API will provide a response based, at least in part, on execution of the smart script. The response may be used by the website or application to generate feedback for the user via the GUI. For example, initial inputs may be provided to the smart ramp via the API, and the smart ramp may return network fees and/or other transaction fees. The GUI may present the fees to the user and request confirmation of the purchase. In another example, the smart ramp may provide outputs related to the status of the transactions (e.g., pending, executed, failed). The site or application may use these outputs to provide information to the user via the GUI (e.g., credit card declined, item delivered).

An example of an API flow for the NFT transaction described with reference to FIG. 2 and FIG. 3 is disclosed herein. However the NFT application and the scripts are provided solely for illustrative purposes and the scripts are not limited to the specific code presented herein. Different coding structures can also be adapted to reproduce the techniques that are the subject matter of this disclosure, and the scope of invention is not limited by these examples, except as expressly recited in the language of the claims.

A site may create a smart ramp checkout instance when smart script parameters are passed in. The smart script module of the smart ramp may validate the smart script parameters and calculate the total cost of the wallet order (cost of input tokens+network fees). In some examples, the total cost of the wallet order may further include transaction fees charged by the smart entity or service provider (cost of input tokens+network fees+transaction fees). This may be referred to as a “reservation”:

```
{
  “sourceCurrency”: “USD”,
  “amountIncludeFees”: “false”,
  “referrerAccountId”: “AC_ZERR2JJFP93”,
  “country”: “US”,
  “dest”: “SMART_SCRIPT_DEFINITION:niftyswapPurchaseNFT”,
  “paymentMethod”: “debit-card”,
  “smartScriptParameters”: {
    “chainId” : “matic”,
    “recipient”:
    “0x5fC6B4DAd2aB87fCeEbEAbe8acc678F00F947E3D”,
    “tokenIds”: [
      65537,
      65538
    ], “tokensBoughtAmounts”: [
        100,
        100
    ], “maxCurrency”: 8.00
  }
}
```

Key inputs (e.g., request fields) of the reservation include:
dest: smart script definition SRN.

To use the “Niftyswap” smart script, for example, the value should be:
SMART SCRIPT DEFINITION:niftyswapPurchaseNFT
amountIncludeFees: Must be set to false.
smartScriptParameters:
chainld: ID of the chain that the smart script will be executed on. Niftyswap presently
supports matic (Polygon).
recipient: Public address for the end user's wallet that will be receiving the ERC-1155
token(s).
tokenlds: Token ID(s) of the ERC-1155 token(s) that the end user is purchasing.
tokenBoughtAmounts: Amount of each ERC-1155 token that the end user is purchasing.
maxCurrency: Maximum amount of USDC that will be exchanged for the ERC-1155 token(s).

The difference between maximum amount and actual amount used will be sent to the end user's wallet. The output (e.g., response) of the smart ramp to the reservation will be an address and a reservation ID:

```
{
  “url”:
“https://pay.sendwyre.com/purchase?country=US&utm_campaign=AC_ZERR2JJFP93&
utm_medium=widget&sourceCurrency=USD&autoRedirect=false&dest=smart_script_in
vocation%3ASS_2Z4E2Z3HEH&quoteId=U6VG6NT963N&accountId=AC_ZERR2JJF
P93&destAmount=8&amountIncludeFees=false&destCurrency=MUSDC&paymentMeth
od=debit-card&reservation=7YXXNB9HJCZ4MFNE3M3U&utm_source=checkout”,
  “reservation”: “7YXXNB9HJCZ4MFNE3M3U”
}
```

The reservation ID generated from the reservation may be passed by the site to the smart ramp to obtain smart ramp checkout information that may be used by the site to construct its checkout GUI. Key information used to construct the GUI includes the smart ramp wallet order cost, ERC-155 (NFT) tokens, and amount of each token. An example response to the reservation ID is provided here:

```
{
  “amount”: null,
  “sourceCurrency”: “USD”,
  “destCurrency”: “MUSDC”,
  “dest”: “smart_script_invocation:SS_2Z4E2Z3HEH”,
  “referrerAccountId”: “AC_ZERR2JJFP93”,
  “autoRedirect”: false,
  “sourceAmount”: null,
  “destAmount”: 8.000000,
  “amountIncludeFees”: false,
  “street1”: null,
  “city”: null,
  “state”: null,
  “postalCode”: null,
  “country”: “US”,
  “firstName”: null,
  “lastName”: null,
  “phone”: null,
  “email”: null,
  “lockFields”: [
    “country”,
    “destAmount”,
    “amountIncludeFees”,
    “referrerAccountId”,
    “destCurrency”,
    “paymentMethod”,
    “sourceAmount”,
    “sourceCurrency”,
    “dest”
  ],
  “redirectUrl”: null,
  “failureRedirectUrl”: null,
  “paymentMethod”: “debit-card”,
  “referenceId”: null,
  “hideTrackBtn”: null,
  “owner”: null,
  “xlmMemo”: null,
  “smartScriptParameters”: {
    “chainId”: “matic”,
    “recipient”:
    “0x5fC6B4DAd2aB87fCeEbEAbe8acc678F00F947E3D”,
    “tokenIds”: [
      65537,
      65538
    ],
    “tokensBoughtAmounts”: [
      100,
      100
    ],
    “maxCurrency”: 8
  },
  “quote”: {
    “sourceCurrency”: “USD”,
    “sourceAmount”: 13.24,
    “sourceAmountWithoutFees”: 8.00,
    “destCurrency”: “MUSDC”,
    “destAmount”: 8,
    “exchangeRate”: 1,
    “equivalencies”: {
      “CHF”: 7.73,
      “MATIC”: 11.670654164195022773,
      “ARS”: 951.59,
      “MXN”: 159.03,
      “CLP”: 6644.52,
      “AVAXCUSDC”: 8.000000,
      “ZAR”: 126.02,
      “INR”: 620.44,
      “VND”: 185400.00,
      “MUSDC”: 8.000000,
      “THB”: 273.22,
      “AUD”: 11.28,
      “ILS”: 26.73,
      “KRW”: 10088,
      “JPY”: 1022,
      “PLN”: 34.56,
      “GBP”: 6.37,
      “PHP”: 418.02,
      “ISK”: 1044.16,
      “HKD”: 62.80,
      “EUR”: 7.50,
      “COP”: 31620.55,
      “DKK”: 55.78,
      “USD”: 8.00,
      “CAD”: 10.24,
      “MYR”: 35.12,
      “NOK”: 76.96,
      “SGD”: 11.00,
      “CZK”: 184.65,
      “SEK”: 78.69,
      “NZD”: 12.40,
      “BRL”: 38.44
    },
    “fees”: {
      “USD”: 5.00,
      “MUSDC”: 0.240000
    }
  },
  “smartScriptRequest”: true,
  “quoteLockRequest”: true
}
```

Key response fields provided from retrieving the reservation include:
dest: smart script invocation object ID. Smart script invocation object is linked to transfer sourceAmount: Total cost of smart script wallet order denominated in sourceCurrency.

The site may use the information provided by the smart ramp to provide information to the user indicating the total amount of the purchase including fees. The site may further prompt the user for final confirmation. Upon confirmation by the user, the site may create the wallet order which may create a smart script invocation object and smart script execution by the smart ramp may begin.

An example wallet order created by the site is provided below:

```
{
  “reservationId”: “7YXXNB9HJCZ4MFNE3M3U”,
  “sourceCurrency”: “USD”,
  “destCurrency”: “MUSDC”,
  “amount”: “8.000000”,
  “dest”: “smart_script_invocation: SS_2Z4E2Z3HEH”,
  “referrerAccountId”: “AC_ZERR2JJFP93”,
  “givenName”: “daffy”,
  “familyName”: “duck”,
  “email”: “daffy@gmail.com”,
  “phone”: “+18052883333”,
  “referenceId”: “AC_ZERR2JJFP93”,
  “ipAddress”: null,
  “address”: {
    “street1”: “23432 Balboa St”,
    “street2”: null,
    “city”: “San Francisco”,
    “state”: “CA”,
    “postalCode”: “94105”,
    “country”: “US”
  },
    “debitCard”: {
    “number”: “4111111111111111”,
    “year”: 2023,
    “month”: “10”,
    “cvv”: 555
  }
}
```

Key request fields include:
reservationId: Wallet order reservation ID used in the previous two steps.
dest: smart script invocation SRN retrieved from previous step
amount: sourceAmount retrieved from last step

The smart ramp may provide a response via the API to the creation of the wallet order, for example:

```
{
  “id”: “WO_RL6HR8CBDB”,
  “createdAt”: 1653329575915,
  “owner”: “account:AC_GFLY9BPTU4M”,
  “status”: “RUNNING_CHECKS”,
  “orderType”: “DOMESTIC”,
  “sourceAmount”: 13.24,
  “purchaseAmount”: 8.00,
  “sourceCurrency”: “USD”,
  “destCurrency”: “MUSDC”,
  “transferId”: null,
  “dest”: “smart_script_invocation:SS_2Z4E2Z3HEH”,
  “authCodesRequested”: false,
  “blockchainNetworkTx”: null,
  “accountId”: “AC_GFLY9BPTU4M”,
  “paymentMethodName”: null
}
```

Once the wallet order has been created, the site can retrieve the wallet order programmatically from the wallet order creation API response (e.g., the site may make an API call, and the API may provide a response based at least in part, on execution of the smart script). This will include the transfer object ID that can be used to view a smart script invocation object details. An example of a response from the smart ramp via the API to retrieving the wallet order is provided below:

```
{
  “id”: “WO_RL6HR8CBDB”,
  “createdAt”: 1653333064000,
  “owner”: “account:AC_GFLY9BPTU4M”,
  “status”: “PROCESSING”,
  “orderType”: “DOMESTIC”,
  “sourceAmount”: 13.24,
  “purchaseAmount”: 8,
  “sourceCurrency”: “USD”,
  “destCurrency”: “MUSDC”,
  “transferId”: “TF_ZYULJVGCHZX”,
  “dest”: “smart_script_invocation:SS_2Z4E2Z3HEH”,
  “authCodesRequested”: false,
  “blockchainNetworkTx”: null,
  “accountId”: “AC_GFLY9BPTU4M”,
  “paymentMethodName”: “Visa ending 1111”
}
```

Key response fields from the smart ramp include:
transferId: Transfer object ID. Can be used to view the smart script invocation object that is attached to the transfer object
Status: When the status of the wallet order is COMPLETE then the smart script has successfully executed

The smart script invocation object generated by the smart ramp is attached to a transfer created from a wallet order. In some examples, it may be retrieved by calling the GET transfer endpoint. In some examples, there may be a GET smart script invocation object.

The smart script invocation object itself is broken up into three main sections:
smartScriptInvocation, smartScriptInvocationTxs, and smartScriptInvocationTxHistories.

An example spartscriptinvocation is provided below:

```
  “smartScriptInvocation”: {
      “id”: “SS_2Z4E2Z3HEH”,
      “smartScriptDefinition”: “niftyswapPurchaseNFT”,
      “blockchainNetworkId”: “matic”,
      “status”: “COMPLETED”,
      “createdAt”: 1653333024000,
      “updatedAt”: 1653333151000,
      “completedAt”: 1653333151000,
      “expiredAt”: null,
      “failedAt”: null,
      “failureReason”: null,
      “inputs”:
“{\“chainId\”:\“matic\”,\“recipient\”:\“0x5fC6B4DAd2aB87fCeEbEAbe8acc678F00F947
E3D\”,\“tokenIds\”:[65537,65538],\“tokensBoughtAmounts\”:[100,100],\“maxCurrency\”
:8}”,
      “outputs”: “Buying following tokensToken Id : [65537] Amount : [100]\nToken Id
: [65538] Amount : [100]\nTotal Price in USDC : [8]”,
      “ledgerTxId”: “TR_LZGM8Q7APYV”
    },
```

The id is the smart script invocation object ID. The smartScriptDefinition is the smart script definition, which describes which supported smart script is being invoked. The blockchainNetworkId is the ID of chain that the smart script is being executed on and status is the status of smart script execution. Inputs are inputs provided when creating the smart script wallet order reservation and outputs are formatted outputs describing what the smart script is doing.

An example smartScriptInvocationTxs is provided below:

```
    “smartScriptInvocationTx”: {
      “id”: “26AMTG9LXC”,
      “smartScriptInvocationId”: “SS_2Z4E2Z3HEH”,
      “blockchainTxId”: “TR_9TM362ZN4V8”,
      “txOrder”: 2,
      “createdAt”: 1653333024000,
      “status”: “CONFIRMED”
    },
    “blockchainTx”: {
      “id”: “TR_9TM362ZN4V8”,
      “networkTxId”:
“0x7cdf7df3bde0bb5b3a92ab3235513ae91a386b4710f312592062ebbb66a668d3”,
      “blockTime”: 1653333123000,
      “blockhash”:
“0x0e72722f89378872a0c7475eb39cd0e5ad493b1c177f2d3e7e7fceee9c3be45a”,
      “amount”: 3.21417,
      “address”: “0x9b609bf3a3977ee7254210e0a0d835251540c4d5”,
      “memo”: null
    }
  },
  {
    “smartScriptInvocationTx”: {
      “id”: “ZWQA863A2G”,
      “smartScriptInvocationId”: “SS_2Z4E2Z3HEH”,
      “blockchainTxId”: “TR_B2MLCHT7ZY2”,
      “txOrder”: 1,
      “createdAt”: 1653333024000,
      “status”: “CONFIRMED”
    },
    “blockchainTx”: {
      “id”: “TR_B2MLCHT7ZY2”,
      “networkTxId”:
“0x07c3686898c21fde13da5f8c88f67ef365f19b2de6b138a8e4a72f96c620d03d”,
      “blockTime”: 1653333093000,
      “blockhash”:
“0x7e6fc9a7d03d1adfa8dcf5626386ab2223bd7749f94263ff4501a774857fc544”,
      “amount”: 8,
      “address”: “0x2791bca1f2de4661ed88a30c99a7a9449aa84174”,
      “memo”: null
    }
```

The id is the smart script invocation transaction ID and the smartScriptInovationId is the smart script invocation ID. The txOrder is the transaction's position within the sequence, the status is status of the smart script invocation transaction. WAITING: Transaction constructed and is waiting to be broadcast. PENDING: Transaction broadcasted to the network but not yet confirmed. CONFIRMED: Transaction confirmed. The networkTxId is the on-chain transaction hash of the smart script invocation transaction. The confirmations is the number of on-chain confirmations. The blockTime is the time it takes the miners or validators within a network to verify transactions within one block and produce a new block in that blockchain. The blockhash is the reference number for a block in the blockchain.

The address is the “To” address of an on-chain transaction. Usually the address of a smart contract. The sourceAddress is the “From” address of an on-chain transaction. In some examples, this is the address of the wallet used by the smart ramp to make the purchase with a digital asset (e.g., cryptocurrency). Because the smart ramp maintains a wallet for digital assets used to purchase the NFT, the user does not need to set up their own wallet to hold the digital asset needed to buy the NFT. In this example using the NFT, the user may enable a wallet to receive the NFT. However, in other examples where the item does not require a wallet, the user may not need to have any wallet when making a purchase that utilizes the smart ramp.

An example smartScriptInvocationTxHistories is provided below:

```
“smartScriptInvocationTxHistories”: [
    {
      “id”: “2TN6XAMQ2W”,
      “smartScriptInvocationId”: “SS_2Z4E2Z3HEH”,
      “smartScriptInvocationTxId”: “26AMTG9LXC”,
      “createdAt”: 1653333024000,
      “statusDetail”: “Transaction created waiting for broadcast”,
      “status”: “WAITING”
    },
    {
      “id”: “8Y38A2BNJ7B”,
      “smartScriptInvocationId”: “SS_2Z4E2Z3HEH”,
      “smartScriptInvocationTxId”: “ZWQA863A2G”,
      “createdAt”: 1653333118000,
      “statusDetail”: “Transaction confirmed on-chain”,
      “status”: “CONFIRMED”
    },
    {
      “id”: “E7PZ4XCN7X6”,
      “smartScriptInvocationId”: “SS_2Z4E2Z3HEH”,
      “smartScriptInvocationTxId”: “26AMTG9LXC”,
      “createdAt”: 1653333151000,
      “statusDetail”: “Transaction confirmed on-chain”,
      “status”: “CONFIRMED”
    },
    {
      “id”: “FZ3QEAYLEXG”,
      “smartScriptInvocationId”: “SS_2Z4E2Z3HEH”,
      “smartScriptInvocationTxId”: “26AMTG9LXC”,
      “createdAt”: 1653333151000,
      “statusDetail”: “Transaction confirmed on-chain”,
      “status”: “CONFIRMED”
    },
    {
      “id”: “HRTDAPCXX3R”,
      “smartScriptInvocationId”: “SS_2Z4E2Z3HEH”,
      “smartScriptInvocationTxId”: “26AMTG9LXC”,
      “createdAt”: 1653333151000,
      “statusDetail”: “Transaction confirmed on-chain”,
      “status”: “CONFIRMED”
    },
    {
      “id”: “JQHFDGWXYQC”,
      “smartScriptInvocationId”: “SS_2Z4E2Z3HEH”,
      “smartScriptInvocationTxId”: “26AMTG9LXC”,
      “createdAt”: 1653333119000,
      “statusDetail”: “Transaction broadcasted on-chain”,
      “status”: “PENDING”
    },
    {
      “id”: “MYZ7JHGF9D”,
      “smartScriptInvocationId”: “SS_2Z4E2Z3HEH”,
      “smartScriptInvocationTxId”: “ZWQA863A2G”,
      “createdAt”: 1653333024000,
      “statusDetail”: “Transaction created waiting for broadcast”,
      “status”: “WAITING”
    },
    {
      “id”: “ZG6ZGGVN6EV”,
      “smartScriptInvocationId”: “SS_2Z4E2Z3HEH”,
      “smartScriptInvocationTxId”: “ZWQA863A2G”,
      “createdAt”: 1653333090000,
      “statusDetail”: “Transaction broadcasted on-chain”,
      “status”: “PENDING”
    }
  ]
```

For each on-chain transaction contained within the smart script, there will be:
id: smart script invocation transaction history ID
smartScriptInovationId: smart script invocation ID
smartScriptInovationTxId: smart script invocation transaction ID
statusDetail: Details on what part of the transaction execution flow the history belongs to status: Status of the smart script invocation transaction history. Tied to the status of each transaction in smartScriptInvocationTxs.

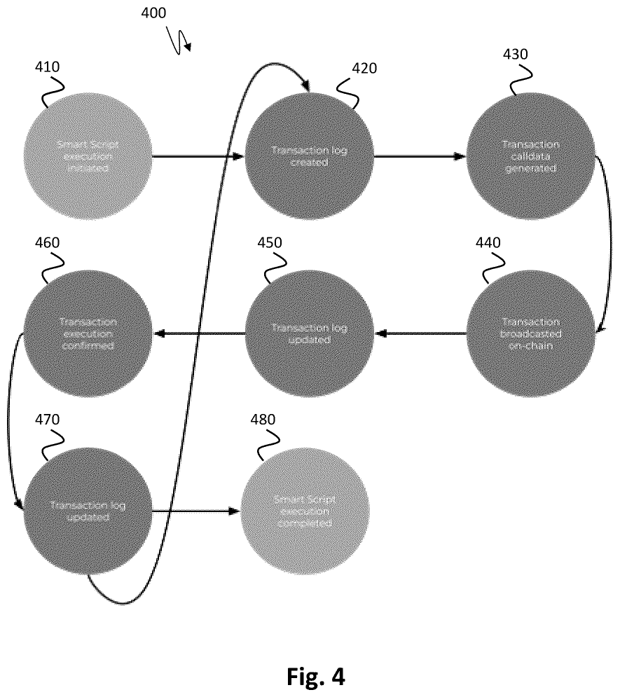

FIG. 4 is a flow chart 400 illustrating the execution flow of a smart ramp in accordance with an example of the present disclosure. The execution flow shown in FIG. 4 may be executed by one or more scripts of the smart ramp. The one or more scripts may be executed by one or more computer servers or similar computing devices. In some examples, the computing device(s) may operate in a cloud-based server network, or other distributed computer network. In some examples, the one or more computing devices executing the smart ramp may be in communication with other server networks or computing devices. For example, a trusted digital transaction entity may be operating an ecommerce site or NFT exchange via one or more blockchain networks. In some examples, the one or more computing devices may be in communication with a payment card or electronic wallet network (e.g., a fiat-based credit network such as VisaNet, or other electronic payment network).

At step 410, smart script (e.g., a script of the smart ramp), execution may be initiated. In some examples, this may be initiated based on inputs received via an API. The smart script may generate a transaction log as indicated by step 420. In step 430, transaction call data may be generated in examples where the transaction being constructed will interact with a smart contract. This may include generating the calldata required to call a smart contract and provide inputs that meet the execution conditions of the smart contract. Once the call data is generated, the transaction (e.g., the smart contract call) may be broadcast on-chain; that is, broadcast to a blockchain network as indicated at step 440. The transaction log may be updated at step 450, indicating that the transaction has bene broadcast. The smart ramp may receive and/or retrieve confirmation from the block chain network that the transaction has been executed at step 460. At step 470, the transaction log may be updated indicating the transaction is complete. If multiple transactions have been requested, the execution flow returns to step 420. If no more transactions remain to be executed, the smart script execution is completed as indicated at step 480.

While the transaction flow shown in FIG. 4 is linear, some steps may be performed in parallel. For example, the execution flow for different transactions may be performed in parallel rather than serially in some embodiments. Although particular steps are shown in a specific order shown in FIG. 4, other combinations of steps and/or orders of steps may be performed in other examples which may be suitable to facilitate an open, secure, encrypted currency/NFT exchange via smart contract-based transactions, as described herein. For example, different types of transactions and/or swap protocols may dictate a different combination or order of steps to be performed by a script.

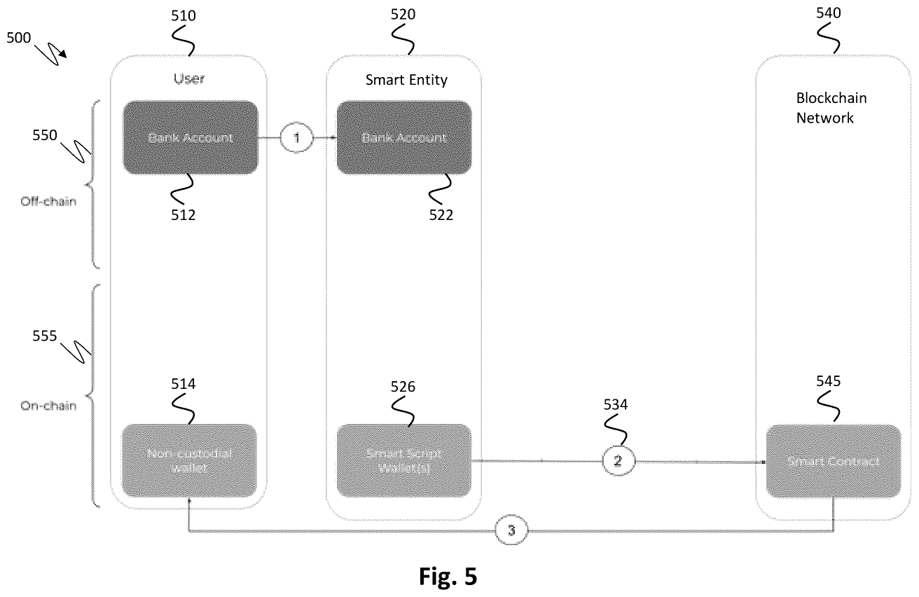

FIG. 5 illustrates the flow of assets 500 implemented by the smart ramp according to an example of the present disclosure. The flow of assets 500 shown in FIG. 5 is based on the purchase of an NFT as described herein.

Block 510 represents assets held by a user (e.g. customer). Block 520 represents assets held by a smart entity (e.g., a trusted transaction service provider). The smart entity may execute or facilitate execution of the smart ramp in some examples. Block 540 represents the assets held by a smart contract deployed on a blockchain network. Transactions in the upper half are off-chain 550, meaning those transfers of assets do not get broadcasted or recorded on a blockchain network. Transactions in the lower half are on-chain 555, and those transfers of assets do get broadcasted and recorded on a blockchain network.

The user may have a bank account 512 that holds funds in a fiat currency (e.g., U.S. dollars). The fiat currency may be transferred from user's fiat account (e.g., bank account, charge account, or NBFI account) to the smart entity or other service provider's account 522 after a wallet order is confirmed as indicated by arrow 1. The smart entity may maintain a smart script wallet 526 capable of interacting with digital assets (e.g., cryptocurrencies). Once the smart entity receives the fiat currency at the bank account 522, the digital asset may be provided from the smart script wallet 526 to the smart contract 545 of the blockchain network 540 as indicated by arrow 2. That is, a transaction associated with the smart script wallet 526 may be broadcast to the blockchain network. Upon receipt of the digital asset, the conditions of the smart contract are met, and the smart contract executes, swapping the digital asset for the NFT and providing the NFT to the user's wallet 514 (in this example a non-custodial wallet). The transfer of assets by the smart ramp may now be complete.

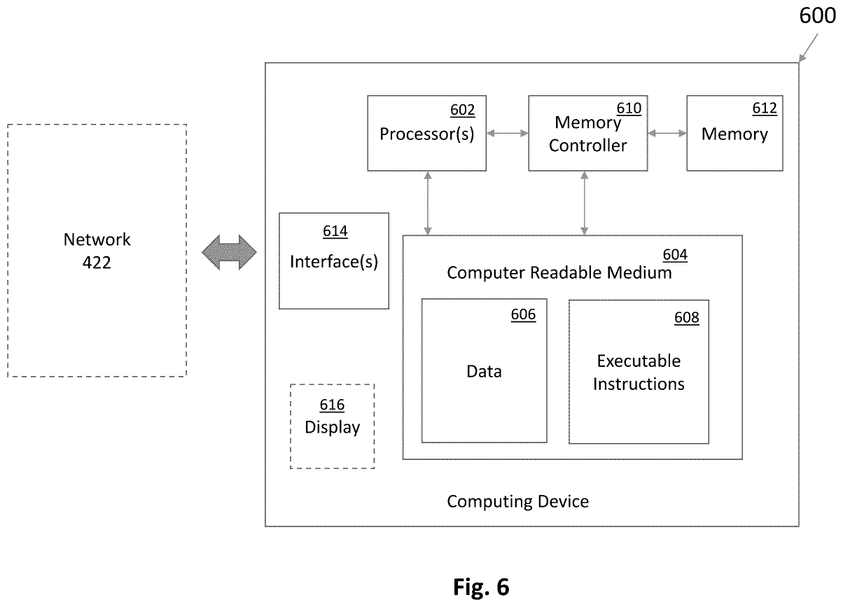

FIG. 6 is a schematic illustration of a computing device arranged in accordance with examples of the present disclosure. The computing device 600 may be used to implement at least a portion of a blockchain network, a smart ramp, an exchange, a site, an application, or a combination thereof. In some examples, the computing device 600 may perform, in whole or in part, any or all of the methods disclosed herein. The computing device 600 may include a processor (or processors) 602, a computer readable medium (or media) 604, a memory controller 610, a memory 612, and an interface (or interfaces) 614. Optionally, in some examples, the computing device 600 may include a display 616. In some examples, the computing device 600 may implement at least a portion of a server, a cloud computing device, a network, or a combination thereof.

The computer readable medium 604 may be accessible to the processor 602. The computer readable medium 604 may be encoded with executable instructions 608. The executable instructions 608 may include executable instructions for implementing a smart ramp in some examples. The executable instructions 608 may be executed by the processor 602. The executable instructions may be scripts in some examples. In some examples, the executable instructions 608 may also include instructions for generating call data, broadcasting transactions, calculating fees, and/or other transactions. Alternatively or additionally, in some examples, the smart ramp, or a portion thereof, may be implemented in hardware included with the computer readable medium 604 and/or processor 602, for example, application-specific integrated circuits (ASICs) and/or field programmable gate arrays (FPGA).

The computer readable medium 604 may store data 606. In some examples, the data 606 may include one or more transaction information, such as items to be purchased, wallet addresses, exchange rates, etc. In some examples, at least some of the data may be received from another computing device or system (e.g., network 422, blockchain network, a cloud computing system). In other examples, some of the data may be generated by the computing device 600. The computer readable medium 604 may be implemented using any medium, including non-transitory computer readable media. Examples include memory, random access memory (RAM), read only memory (ROM), volatile or non-volatile memory, hard drive, solid state drives, or other storage. While a single medium is shown in FIG. 6, multiple media may be used to implement computer readable medium 604.

In some examples, the processor 602 may be implemented using one or more central processing units (CPUs), graphical processing units (GPUs), ASICs, FPGAs, or other processor circuitry. In some examples, the processor 602 may execute some or all of the executable instructions 608. In some examples, the processor 602 may be in communication with a memory 612 via a memory controller 610. In some examples, the memory 612 may be volatile memory, such as dynamic random access memory (DRAM). The memory 612 may provide information to and/or receive information from the processor 602 and/or computer readable medium 604 via the memory controller 610 in some examples. While a single memory 612 and a single memory controller 610 are shown, any number may be used. In some examples, the memory controller 610 may be integrated with the processor 602.

In some examples, the interface 614 may provide a communication interface to another device (e.g., network 622), a user, and/or a network (e.g., LAN, WAN, Internet). The interface 614 may be implemented using a wired and/or wireless interface (e.g., Wi-Fi, Bluetooth, HDMI, USB, etc.). In some examples, the interface 614 may include user interface components which may receive inputs from a user. Examples of user interface components include a keyboard, a mouse, a touch pad, a touch screen, and a microphone. In some examples, the interface 614 may communicate information between external devices (e.g., network 622) and one or more components of the computing device 600 (e.g., processor 602 and computer readable medium 604).

### Examples

In various examples and embodiments, suitable methods can be provided for receiving at a script, a first input indicating an item for purchase, and responsive to the first input, calculating a transaction fee with the script. The script may be adapted to provide a transaction fee and a price of the item (e.g., in a currency, such as a fiat currency). A first wallet may be configured to receive a payment in the currency. In some examples and embodiments, the payment is equal to or greater than a sum of the transaction fee and the price. Responsive to receiving the payment, the script may be adapted to cause a digital asset to be provided from a second wallet and an indication of the item to a smart contract, wherein providing the digital asset and the indication of the item causes the smart contract to execute. The item may be purchased upon execution of the smart contract. As used herein, “a smart contract” can apply equally to a smart contract executable on a blockchain network, and one, two, three, four or more smart contracts, executable to perform any of the functions described in this disclosure.

Any of these examples and embodiments may include receiving at the script, a second input indicating a delivery location for the item. The delivery location may include a third wallet, wherein the item is automatically delivered to the third wallet upon execution of the smart contract.

In any of these examples and embodiments, the script may be adapted to provide a confirmation of execution of the smart contract.

In any of these examples and embodiments, the script may be adapted to generate a transaction log based, at least in part, on the first input. The script may be further adapted to update the transaction log after execution of the smart contract.

Depending on the application, providing the digital asset and the indication of the item to the smart contract may include generating transaction call data based, at least in part, on the digital asset and the indication of the item and broadcasting the transaction call data to a blockchain network.

Depending on the application, the first input may be provided to the script via an application programing interface (API) and the transaction fee and the price of the item in the currency is provided from the script to the API. In some examples, the API may provide outputs from the script to another computing device, network, server, script, and/or software. For example, outputs from the script provided via the API may be used by a software program (e.g., computer executable instructions, which may be another script in some examples) on a computing device or network to generate at least a portion of a graphical user interface (GUI) and/or outputs provided via the GUI. In some examples, the API may receive inputs from the program on the computing device or network and provide the inputs to the script. Thus, the API may facilitate interaction between the script and other software, computing devices, and/or networks. For example, inputs to the script from computing device may provide information used for the script to execute one or more transactions. In another example, outputs from the script may allow software implementing a GUI to provide an order confirmation notice to a customer.

In any of these examples and embodiments, the item may be a second digital asset or a physical asset. The second digital asset may be a non-fungible token.

Depending on the application, the script may be adapted to, responsive to receiving the payment, cause the digital asset to be purchased and delivered to the second wallet.

In various examples and embodiments, at least one non-transitory computer-readable medium may be encoded with instructions that when executed by at least one processor of at least one computing device in communication with a blockchain network, in order to perform any of the above functions.

The instructions can further or alternatively be executable by the at least one process calculate a transaction fee associated with purchasing an item and provide a sum of the transaction fee and a price of the item in a currency.

Responsive to receiving a payment in the currency equal to or greater than the sum, the instructions may be executed to broadcast a transaction to the blockchain network, wherein broadcasting causes a digital asset to be provided from a second wallet and an indication of the item to provided to a smart contract of the blockchain network. The smart contract may automatically execute upon the broadcast and the item may be purchased upon execution of the smart contract.

The instructions may be executed provide a confirmation of execution of the transaction.

In any of the examples and embodiments, the instructions may be executable to generate a transaction log, update the transaction log after broadcasting the transaction, confirm execution of the transaction, and update the transaction log after confirming execution.

Depending on the application, the digital asset may be a cryptocurrency.

The instructions may be executed to cause execution of a credit card transaction for an amount in the currency equal to or greater than the sum, wherein execution of the credit card transaction causes the payment to be received.

Depending on the application, the transaction fee may include a credit card processing fee, a blockchain network fee, a service fee, or a combination thereof.

The instructions may be executed to cause the at least one computing device to calculate an exchange rate between the currency and the digital asset.

In various examples and embodiments, suitable methods can be provided for receiving an indication of a plurality of items to be purchased. A script may be adapted to cause execution of an off-chain transaction to provide a payment of a currency to a first wallet, causing, with the script, execution of a plurality of on-chain transactions, wherein an on-chain transaction of the plurality of on-chain transactions comprises providing a digital asset from a second wallet to a third digital wallet in exchange for an item of the plurality of items.

Depending on the application, a second on-chain transaction of the plurality of on-chain transactions may include providing the digital asset to the second wallet. The second on-chain transaction of the plurality of transactions may be executed responsive to receiving the payment of the currency.

Depending on the application, the script may be adapted to cause execution of the plurality of on-chain transactions to include broadcasting a smart contract call. The smart contract call may cause execution of a smart contract of a blockchain network.

Depending on the application, the item of the plurality of items may be a second digital asset. In these examples and embodiments, the item may automatically be delivered to a fourth wallet upon execution of the on-chain transaction of the plurality of on-chain transactions.

Depending on the application, the currency may be a fiat currency or a second digital asset different from the digital asset. For example, the second digital asset may be a crypto currency and the digital asset may be an NFT.

In any example or embodiment, the indication may be received by an application program interface (API) associated with the script. In these examples, suitable methods may further include providing via the API a status of execution of the script.

From the foregoing it will be appreciated that specific embodiments of the disclosure have been described for purposes of illustration. Various modifications may be made to these teachings, without deviating from the spirit and scope of the disclosure, which is not limited to any of the specific embodiments described herein, but defined by the language of the appended claims.

What is claimed is:

1. A method, comprising:
receiving at a script, a first input indicating an item for purchase;
responsive to the first input, calculating, with the script, a transaction fee;
providing via the script, the transaction fee and a price of the item in a currency;
receiving at a first wallet, a payment in the currency, wherein the payment is equal to or greater than a sum of the transaction fee and the price; and
responsive to receiving the payment, with the script, causing a digital asset to be provided from a second wallet and an indication of the item to a smart contract, wherein providing the digital asset and the indication of the item causes the smart contract to execute, wherein the item is purchased upon execution of the smart contract.

2. The method of claim 1, further comprising receiving at the script, a second input indicating a delivery location for the item.

3. The method of claim 2, wherein the delivery location comprises a third wallet, wherein the item is automatically delivered to the third wallet upon execution of the smart contract.

4. The method of claim 1, further comprising providing via the script a confirmation of execution of the smart contract.

5. The method of claim 1, further comprising generating with the script a transaction log based, at least in part, on the first input.

6. The method of claim 5, further comprising updating the transaction log after execution of the smart contract.

7. The method of claim 1, wherein providing the digital asset and the indication of the item to the smart contract comprises:
generating transaction call data based, at least in part, on the digital asset and the indication of the item; and
broadcasting the transaction call data to a blockchain network.

8. The method of claim 1, wherein the first input is provided to the script via an application programing interface (API) and the transaction fee and the price of the item in the currency is provided from the script to the API.

9. The method of claim 1, wherein the item comprises a second digital asset.

10. The method of claim 9, wherein the second digital asset comprises a non-fungible token.

11. The method of claim 1, further comprising responsive to receiving the payment, causing with the script, the digital asset to be purchased and delivered to the second wallet.

12. At least one non-transitory computer-readable medium encoded with instructions that when executed by at least one processor of at least one computing device in communication with a blockchain network, cause the at least one computing device to:
calculate a transaction fee associated with purchasing an item;
provide a sum of the transaction fee and a price of the item in a currency;
responsive to receiving a payment in the currency equal to or greater than the sum, broadcast a transaction to the blockchain network, wherein broadcasting causes a digital asset to be provided from a second wallet and an indication of the item to provided to a smart contract of the blockchain network, wherein the smart contract automatically executes upon the broadcast and the item is purchased upon execution of the smart contract.

13. The at least one non-transitory computer-readable medium of claim 12, wherein the instructions further cause the at least one computing device to provide a confirmation of execution of the transaction.

14. The at least one non-transitory computer-readable medium of claim 12, wherein the instructions further cause the at least one computing device to:
generate a transaction log;
update the transaction log after broadcasting the transaction;
confirm execution of the transaction; and
update the transaction log after confirming execution.

15. The at least one non-transitory computer-readable medium of claim 12, wherein the digital asset comprises a cryptocurrency.

16. The at least one non-transitory computer-readable medium of claim 12, wherein the instructions further cause the at least one computing device to cause execution of a credit card transaction for an amount in the currency equal to or greater than the sum, wherein execution of the credit card transaction causes the payment to be received.

17. The at least one non-transitory computer-readable medium of claim 12, wherein the transaction fee comprises a credit card processing fee, a blockchain network fee, a service fee, or a combination thereof.

18. The at least one non-transitory computer-readable medium of claim 12, wherein the instructions further cause the at least one computing device to calculate an exchange rate between the currency and the digital asset.

19. A method comprising:
receiving an indication of a plurality of items to be purchased;
causing, with a script, execution of an off-chain transaction to provide a payment of a currency to a first wallet;
causing, with the script, execution of a plurality of on-chain transactions, wherein an on-chain transaction of the plurality of on-chain transactions comprises providing a digital asset from a second wallet to a third digital wallet in exchange for an item of the plurality of items.

20. The method of claim 19, wherein a second on-chain transaction of the plurality of on-chain transactions comprises providing the digital asset to the second wallet.

21. The method of claim 20, wherein the second on-chain transaction of the plurality of transactions is executed responsive to receiving the payment of the currency.

22. The method of claim 19, wherein causing execution of the plurality of on-chain transactions comprises broadcasting, with the script, a smart contract call, wherein the smart contract call causes execution of a smart contract of a blockchain network.

23. The method of claim 19, wherein the item of the plurality of items is a second digital asset and is automatically delivered to a fourth wallet upon execution of the on-chain transaction of the plurality of on-chain transactions.

24. The method of claim 19, wherein the currency comprises a fiat currency or a second digital asset different from the digital asset.

25. The method of claim 19, wherein the indication is received by an application program interface (API) associated with the script.

26. The method of claim 25, further comprising providing via the API a status of execution of the script.
